(19) United States
(12) Patent Application Publication
(10) Pub. No.: US 2015/0180329 A1
(43) Pub. Date: Jun. 25, 2015

(54) AC/DC CONVERTER AND AC/DC CONVERTING METHOD

(71) Applicant: Fujitsu Limited, Kawasaki-shi (JP)

(72) Inventors: Yukio YOSHINO, Tokorozawa (JP); Hiroshi SHIMAMORI, Yokosuka (JP)

(21) Appl. No.: 14/564,402

(22) Filed: Dec. 9, 2014

(30) Foreign Application Priority Data
Dec. 19, 2013 (JP) 2013-262929

(51) Int. Cl. H02M 1/42; H02M 3/335

(52) U.S. Cl. CPC H02M 1/4208; H02M 3/33546

(57) ABSTRACT

An AC/DC converter includes: a rectifier circuit that rectifies an alternating current input; a PFC circuit that has an inductance element, a switching element, and a diode and steps up and outputs an output of the rectifier circuit; a DC/DC converting circuit that converts an output of the PFC circuit into a direct current voltage power source of a predetermined voltage value; a target voltage command generating circuit that designates the target voltage so that the target voltage is low in a region; a target voltage converting circuit that generates a converted target voltage by converting the target voltage designated by the target voltage command generating circuit so that the target voltage is changed in a first period; and a voltage command generating circuit that generates an on and off control signal for controlling on and off of the switching element of the PFC circuit.

### CROSS-REFERENCE TO RELATED APPLICATIONS

This application is based upon and claims the benefit of priority of the prior Japanese Patent Application No. 2013-262929, filed on Dec. 19, 2013, the entire contents of which are incorporated herein by reference.

### FIELD

The embodiments discussed herein are related to an AC/DC converter and an AC/DC converting method.

### BACKGROUND

An AC/DC converter that converts an alternating current into a direct current is widely used in a power source of an electronic apparatus. In general, an AC/DC converter has to operate at an operating point that achieves as efficient operation as possible in order to keep the running cost of an electronic apparatus low. Furthermore, it is desirable that an AC/DC converter contain fewer harmonics.

In general, a commercial alternating current power source in a range from 100 V to 240 V is inputted to an AC/DC converter, and a direct-current voltage (pulsating current) is formed through full-wave rectification using a diode element. This direct-current voltage is stepped up by switching on and off of a switching element of a power factor correction (PFC) circuit. The voltage thus stepped up is once converted from a direct current into an alternating current by switching on and off of a switching element of a single-ended forward converter in a DC/DC converting circuit, is stepped down by inputting the alternating current to an isolation transformer, and is then converted into a direct current by a rectifier circuit. In this way, the voltage is finally converted into a direct current of a low voltage in a range from 12 V to 48 V.

For example, a CPU is switched between a high-load processing state and an idling state in order to achieve an energy-saving function in a server apparatus. There are cases where a power source unit mounted in the apparatus is switched on or off accordingly. When such an operation occurs, the current consumed markedly fluctuates. This influences the voltage, and the voltage fluctuation also becomes large. Such a large voltage fluctuation causes malfunction of the apparatus. Therefore, the voltage fluctuation of the power source has to be reduced in order to achieve stable operation of the server apparatus.

In general, when the response speed of a power source circuit is high, the voltage fluctuation is small, whereas when the response speed is low, the voltage fluctuation is large.

The main causes of loss in a PFC circuit are classified into switching loss of an FET etc. and resistive loss of a diode, an FET, a choke coil, etc. Although the ratio between these losses varies depending on the specification of the circuit, the percentage of the switching loss is larger in a region where an output electric current is low, and the percentage of the resistive loss is larger in a region where an output electric current is high. Accordingly, in the region where an output electric current is low, reducing an output voltage of the PFC circuit (reducing a step-up ratio), which reduces the switching loss, achieves higher conversion efficiency. Meanwhile, in the region where an output electric current is high, increasing the output voltage of the PFC circuit, which reduces the electric current and the resistive loss, is more efficient. Because of this, conventionally, an output voltage of a PFC circuit is set to one that achieves high efficiency in accordance with an electric current value requested for a system.

In order to further improve the efficiency of an AC/DC converter, a technique of switching an output voltage of a PFC circuit in accordance with a load (output electric current) is proposed. In such an AC/DC converter, an output electric current of a DC/DC converting circuit is detected, and a target voltage is designated so that an output voltage of a PFC circuit is low in a region where the output electric current is low and the output voltage of the PFC circuit is high in a region where the output electric current is high. Then, on and off of an FET of the PFC circuit is controlled so that the output voltage of the PFC circuit becomes the target voltage. As a result, the PFC circuit outputs an output voltage in accordance with the target voltage, and a high efficiency is achieved throughout a wide load (output electric current) value range.

However, in this AC/DC converter, the output voltage of the PFC circuit is decreased when a low output electric current is detected, and the output voltage of the PFC circuit is increased when a high output electric current is detected. Therefore, in a case where the output electric current fluctuates over a short cycle, the output voltage of the PFC circuit fluctuates in the middle of the transition of the output voltage from a high voltage to a low voltage or vice versa. Consequently, the output voltage of the PFC circuit is undesirably not stable.

In view of this, a technique has been proposed for delaying switching of the PFC from on to off by turning on the PFC circuit and thereby increasing the output voltage of the PFC circuit in a case where a load (output) is high and by turning off the PFC circuit and thereby decreasing the output voltage of the PFC circuit in a case where the load (output electric current) is low.

In general, in order to increase the response speed, it is desirable that the output voltage of the PFC circuit be high. Meanwhile, in order to increase the efficiency, it is desirable that the output voltage of the PFC circuit be low in a region where a load (output electric current) is low.

In the arrangement in which the PFC control circuit is turned on or off, when the output electric current becomes low, the PFC circuit is stopped, that is, the output voltage of the PFC circuit is decreased. Accordingly, the response speed is low, and when an electric current fluctuation occurs, a voltage fluctuation undesirably becomes large. In addition, when the output electric current becomes large again, the PFC circuit is activated, but it takes a certain time to activate the PFC circuit. In this case, the PFC circuit is under no control for the certain time. Accordingly, the response speed becomes low, and when an electric current fluctuation occurs, the voltage fluctuation becomes large.

The following is reference documents:

[Document 1] Japanese Laid-open Patent Publication No. 2009-261042 and

[Document 2] International Publication Pamphlet No. WO2004/059822.

### SUMMARY

According to an aspect of the invention, an AC/DC converter includes: a rectifier circuit that rectifies an alternating current input; a PFC circuit that has an inductance element, a switching element, and a diode and steps up and outputs an output of the rectifier circuit in accordance with a target voltage by controlling on and off of the switching element; a DC/DC converting circuit that converts an output of the PFC circuit into a direct current voltage power source of a predetermined voltage value; a target voltage command generating circuit that designates the target voltage so that the target voltage is low in a region where an output electric current of the DC/DC converting circuit is low and so that the target voltage is high in a region where the output electric current of the DC/DC converting circuit is high; a target voltage converting circuit that generates a converted target voltage by converting the target voltage designated by the target voltage command generating circuit so that the target voltage is changed in a first period when the output electric current of the DC/DC converting circuit is shifted from low to high and so that the target voltage is changed in a second period longer than the first period when the output electric current of the DC/DC converting circuit is shifted from high to low; and a voltage command generating circuit that generates an on and off control signal for controlling on and off of the switching element of the PFC circuit in accordance with the converted target voltage.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIGS. 1A and 1B are diagrams illustrating a circuit configuration of a general AC/DC converter, FIG. 1A is a circuit block diagram, and FIG. 1B is a circuit diagram;

FIG. 2 is a diagram illustrating a specific circuit example of a voltage command generating circuit in FIGS. 1A and 1B;

FIG. 3 is a timing diagram illustrating operation of a PFC circuit of FIG. 2;

FIG. 4 is a diagram illustrating how circuit efficiency changes depending on a ratio of an output electric current to a rated electric current at different output voltages (370 V and 400 V) of the PFC circuit;

FIG. 5 is a diagram illustrating a circuit configuration of an AC/DC converter that changes an output voltage of the PFC circuit;

FIG. 6 is a timing diagram illustrating operation of the PFC circuit of FIG. 5;

FIG. 7 is a circuit diagram of an AC/DC converter that uses another control method of switching an output voltage of a PFC circuit;

FIG. 8 is a timing diagram illustrating operation of the AC/DC converter of FIG. 7;

FIG. 9 is a diagram illustrating a circuit configuration of an AC/DC converter according to the first embodiment;

FIG. 10 is a timing diagram illustrating operation of a target voltage converting circuit of the AC/DC converter according to the first embodiment;

FIG. 11 is a diagram illustrating a circuit configuration of an AC/DC converter according to the second embodiment.

### DESCRIPTION OF EMBODIMENTS

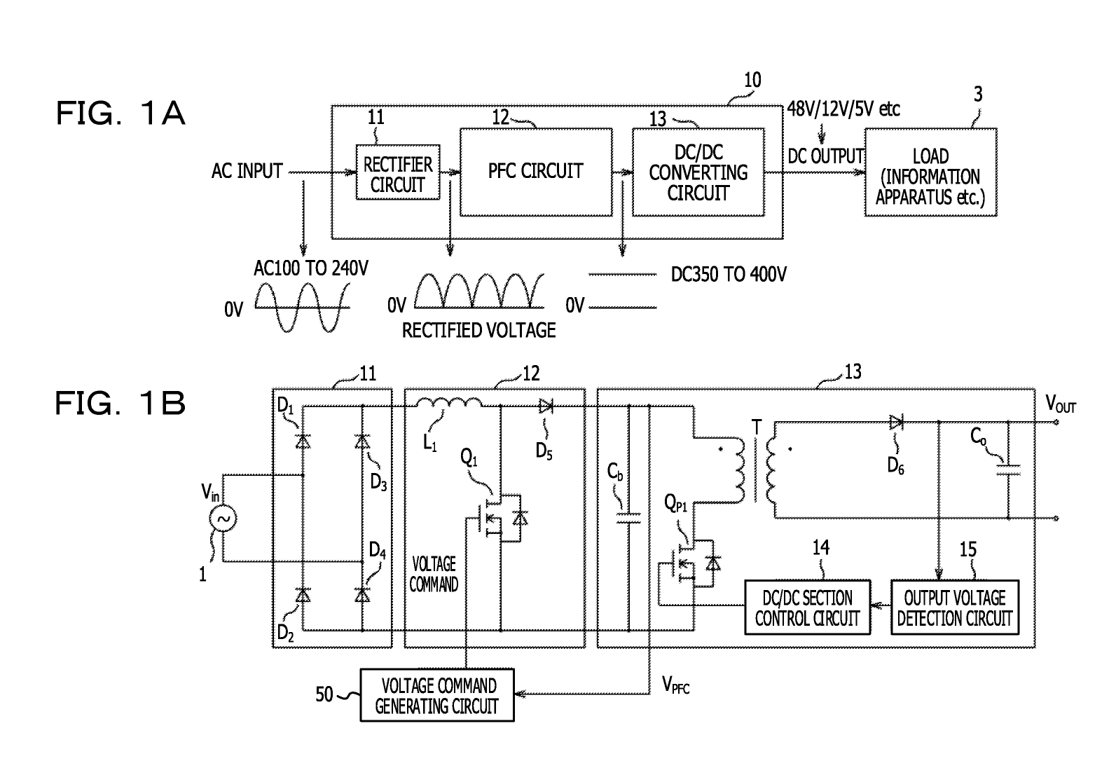

A general AC/DC converter is described before describing embodiments. FIGS. 1A and 1B are diagrams illustrating a circuit configuration of a general AC/DC converter. FIG. 1A is a circuit block diagram, and FIG. 1B is a circuit diagram.

For example, an AC/DC converter 10 receives input of an alternating current (AC) from a 100 V to 240 V commercial power source 1, converts the alternating current into a direct current, steps up the direct current, converts the direct current into a predetermined direct current voltage in a range from 12 V to 48 V (DC/DC conversion), and then outputs the direct current voltage to a load (for example, information apparatus) 3.

As illustrated in FIGS. 1A and 1B, the AC/DC converter 10 includes a rectifier circuit 11 that rectifies an alternating current (AC) input so as to convert the alternating current into a direct current, a PFC circuit 12 that steps up the direct current voltage outputted from the rectifier circuit, and a DC/DC converting circuit 13 that isolates and steps down an output of the PFC circuit 12. Although there are various circuit types as the rectifier circuit 11, the PFC circuit 12, and the DC/DC converting circuit 13, the following description discusses, as an example, the circuit illustrated in FIGS. 1A and 1B.

The rectifier circuit 11 has four diode elements that are connected to each other. This forms a full-wave rectification waveform of a direct current voltage. The PFC circuit 12 steps up the direct current voltage outputted from the rectifier circuit 11 by switching on or off a switching element (FET) Q₁. For example, the PFC circuit 12 steps up the direct current voltage to a voltage in a range from DC 350 V to 400 V. A voltage command generating circuit 50 generates a voltage command that switches on or off the switching element Q₁ in accordance with the output voltage of the PFC circuit 12 (a terminal voltage of a capacitor Cb in FIGS. 1A and 1B).

The DC/DC converting circuit 13 receives the voltage stepped up by the PFC circuit 12, converts the direct current into an alternating current once by switching on or off a switching element Qₚ₁ of a single-ended forward converter, and then outputs the alternating current to an insulation transformer T. The voltage stepped down by the transformer T is converted into a direct current by a rectifier circuit made up of a diode D₆ and a capacitor Cₒ so as to be finally converted into a direct current of a low voltage in a range from 12 V to 48 V, and is then outputted to the load 3. An output voltage detection circuit 15 detects an output voltage Vₒᵤₜ, and a DC/DC section control circuit 14 switches on or off a switching element Qₚ₁ so that the output voltage Vₒᵤₜ becomes a predetermined voltage.

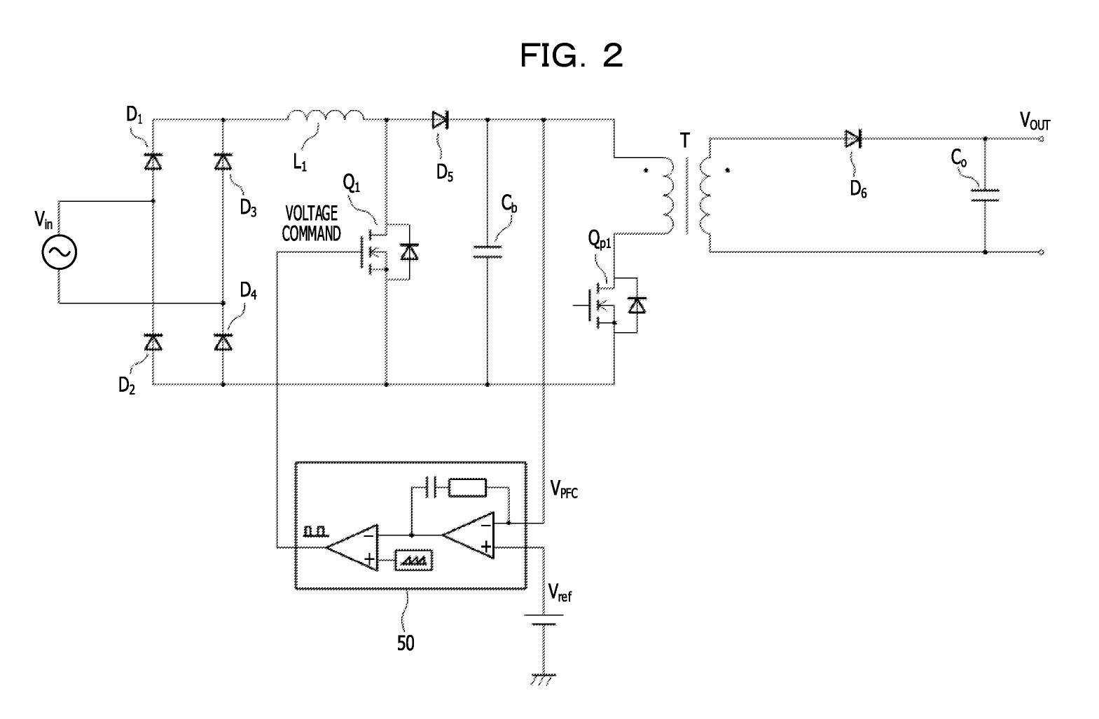

FIG. 2 is a circuit diagram illustrating a specific circuit example of the voltage command generating circuit 50 in FIGS. 1A and 1B. Note that, for simplification of FIG. 2, illustration of the DC/DC section control circuit 14 and the output voltage detection circuit 15 is omitted. Also in the subsequent drawings, these circuit blocks may be omitted.

As illustrated in FIG. 2, the voltage command generating circuit 50 generates a difference voltage between the output voltage Vₒᵤₜ and a reference potential V_{ref}, compares the difference voltage with a triangular wave, and then generates a voltage command which is a PWM (Pulse Width Modulation) signal. The reference potential V_{ref} is a fixed value. In this way, the PFC circuit 12 of FIG. 2 detects the output voltage V_{PFC} of the PFC circuit 12 and feeds back a detected value, and the voltage command generating circuit 50 outputs a voltage command that switches on or off Q₁ so that V_{PFC} becomes a target voltage V_{ref} which is a fixed value. As a result, the output voltage V_{PFC} of the PFC circuit 12 is kept invariable.

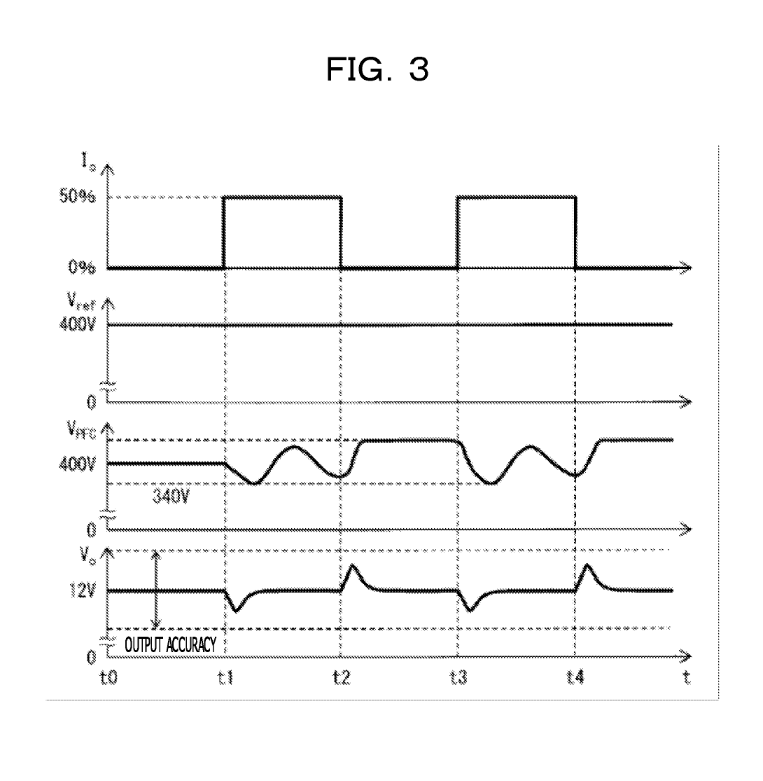

FIG. 3 is a timing diagram illustrating operation of the PFC circuit 12 of FIG. 2. In FIG. 3, the reference potential V_{ref} is fixed to 400 V. During a period t0 to t1, an output electric current I_{O} is 0% and the output voltage V_{PFC} of the PFC circuit 12 is steady, that is, is not changed. During a period t1 to t2, when the output electric current I_{O} rapidly increases from 0% to 50%, the output voltage V_{PFC} of the PFC circuit 12 decreases. In this case, the PFC circuit 12 tries to follow 400 V at a response speed of V_{ref}=400 V, but the output voltage V_{PFC} of the PFC circuit 12 fluctuates, and an output voltage V_{O} of the AC/DC converter 10 also fluctuates as illustrated in FIG. 3.

During a period t2 to t3, when the output electric current I_{O} rapidly decreases from 50% to 0%, the output voltage V_{PFC} of the PFC circuit 12 increases and reaches an overvoltage detection point of the PFC circuit 12. When the output voltage V_{PFC} of the PFC circuit 12 reaches the overvoltage detection point, feedback is saturated, and the voltage becomes invariable. During a period t3 to t4, the output electric current I_{O} increases again from 0% to 50%, and the output voltage V_{PFC} of the PFC circuit 12 decreases as in the case of t2.

As described above, the PFC circuit 12 described with reference to FIGS. 1A, 1B, 2, and 3 has a problem that in a case where an output electric current fluctuates over a short cycle, an output voltage of the PFC circuit 12 is not stable. Since the circuit illustrated in FIG. 1B is well known, further explanation is omitted.

The main causes of loss in the PFC circuit 12 are classified into switching loss of a diode D₅ and Q₁ (FET), etc. and resistive loss of the diode D₅, Q₁ (FET), a choke coil L₁, etc. Although the ratio between these losses varies depending on the specification of the circuit, the percentage of the switching loss is larger in a region where an output electric current is low, and the percentage of the resistive loss is larger in a region where an output electric current is high. Accordingly, in the region where an output electric current is low, reducing an output voltage (reducing a step-up ratio), which reduces the switching loss, achieves a higher conversion efficiency. Meanwhile, in the region where an output electric current is high, increasing an output voltage, which reduces the electric current and the resistive loss, is more efficient. Because of this, conventionally, the output voltage of the PFC circuit 12, that is, the reference potential V_{ref} is set to one that achieves high efficiency in accordance with an electric current value requested for a system.

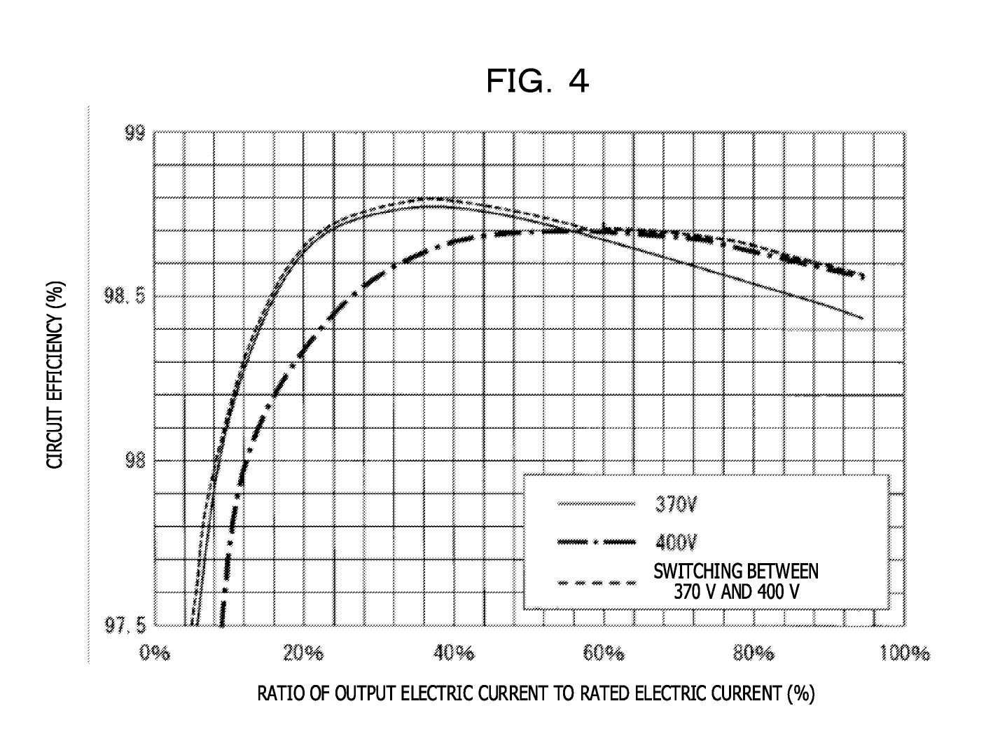

FIG. 4 is a diagram illustrating how circuit efficiency changes depending on a ratio of an output electric current to a rated electric current at different output voltages (370 V and 400 V) of the PFC circuit 12.

The characteristic of conversion efficiency of the PFC circuit 12 varies depending on the output electric current. As indicated by the solid line in FIG. 4, in a region where the output electric current is low, the conversion efficiency is higher in a case where the output voltage of the PFC circuit 12 is set to 370 V. Meanwhile, as indicated by the alternate long and short dash line, in a region where the output electric current is high, the conversion efficiency of the PFC circuit 12 is higher in a case where the output voltage is set to 400 V.

However, according to the circuit of FIG. 2, the output voltage V_{PFC} of the PFC circuit 12 may not be changed. Accordingly, the circuit of FIG. 2 may not be operated at an operation point that achieves higher efficiency in the region where an electric current is low or the region where an electric current is high. Furthermore, a server achieves the following energy-saving functions from the perspective of a reduction of running cost and environmental-friendliness through energy-saving. Specifically, a server has a function of switching the CPU between a high-load processing state and an idling state and a function of turning on and off power sources of units mounted in the apparatus. When these operations occur, a fluctuation of electric current consumed becomes large. This influences a voltage fluctuation, and the voltage fluctuation also becomes large. Such a large voltage fluctuation causes malfunction of the apparatus. Therefore, a reduction in the voltage fluctuation and stable operation of the server apparatus are demanded.

The load on the server apparatus fluctuates on the order of (approximately) several μsec to several hundreds of μsec in the case of semiconductor parts, and stable operation of the server apparatus on the order of several msec or more is demanded. Because of these, it is important to reduce a voltage fluctuation of a PFC circuit and a DC/DC converting circuit in an AC/DC converter and a DC/DC converting circuit in a server apparatus.

In view of this, a PFC circuit is proposed which achieves high conversion efficiency even in a region where the output electric current is low and a region where the output electric current is high by performing a control of switching a setting voltage at an intersection of the 370 V efficiency curve and the 400 V efficiency curve illustrated in FIG. 4. In FIG. 4, the intersection of the output voltage 370 V and the output voltage 400 V of the PFC circuit is a point obtained when the output electric current is approximately 60% (the rated output electric current is 100%). Accordingly, the output voltage of the PFC circuit is set to 370 V when the output electric current is less than 60%, and the output voltage of the PFC circuit is set to 400 V when the output electric current is 60% or more.

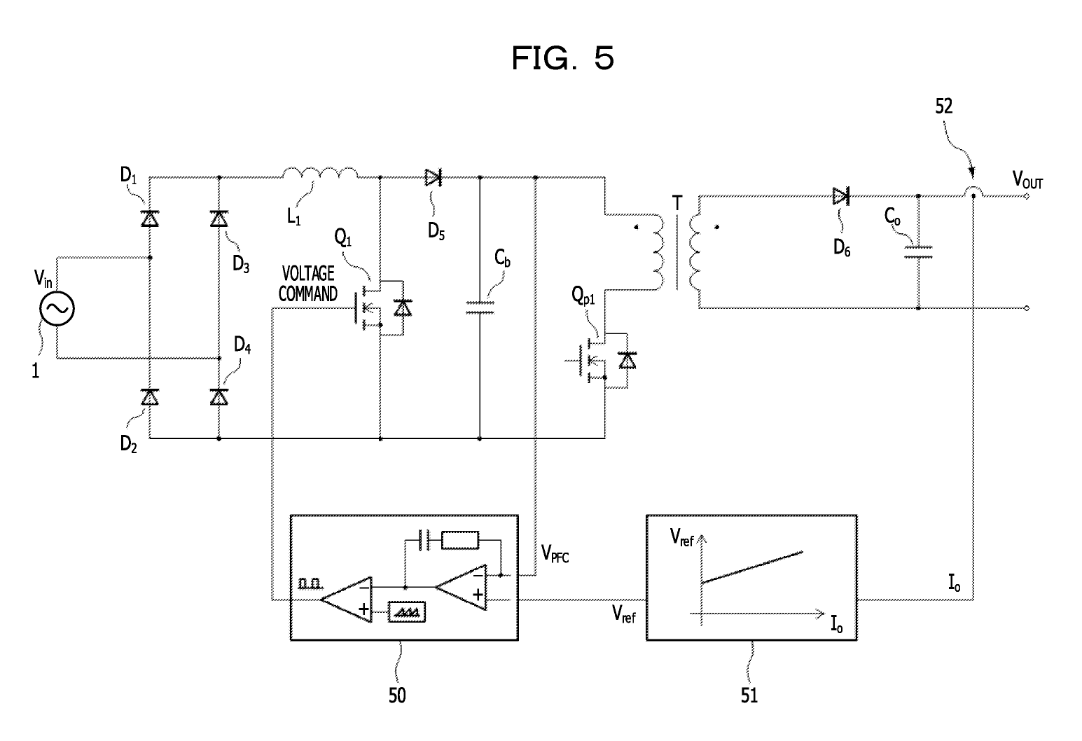

FIG. 5 is a circuit diagram of an AC/DC converter that changes an output voltage V_{PFC} of a PFC circuit 12. The circuit of FIG. 5 is different from the circuit of FIG. 2 in that an output electric current detection circuit 52 that detects an output electric current I_{O} of a DC/DC converting circuit 13 and a target voltage command generating circuit 51 are added. The circuit of FIG. 5 is identical to the circuit of FIG. 2 except for this point. The target voltage command generating circuit 51 generates a target voltage V_{ref} from the output electric current I_{O} of the DC/DC converting circuit 13 that is detected by the output electric current detection circuit 52. Although V_{ref} is a fixed value in the circuit of FIG. 2, the target voltage V_{ref} is designated in the circuit of FIG. 5 so that the target voltage V_{ref} has a small value when the output electric current I_{O} is low and the target voltage V_{ref} has a large value when the output electric current I_{O} is high. The target voltage V_{ref} may change in proportion to the output electric current I_{O} or may change in stages. For example, in a case where the target voltage V_{ref} changes in two stages, the target voltage V_{ref} is designated so that the target voltage V_{ref} of the output voltage of the PFC circuit 12 is low (370 V) in a region where the output electric current I_{O} is low and so that the output voltage V_{FCf} of the PFC circuit 12 is high (400 V) in a region where the output electric current I_{O} is high. The voltage command generating circuit 50 outputs a voltage command that controls on and off of Q₁ so that the output voltage V_{PFC} of the PFC circuit 12 becomes V_{ref} that is outputted by the target voltage command generating circuit 51. As a result, the PFC circuit 12 outputs an output voltage V_{PFC} according to the target voltage V_{ref}. The output voltage V_{PFC} of the PFC circuit 12 varies depending on the output electric current I_{O}, so that the efficiency curve indicated by the broken line in FIG. 4 is realized.

A PFC circuit has the following problem. Specifically, when an output voltage of a PFC circuit is low, response speed to an output electric current fluctuation becomes low, and therefore a voltage fluctuation becomes large. This deteriorates the stability of the circuit. This problem is discussed below by taking, as an example, a PFC circuit having the efficiency characteristic as illustrated in FIG. 4. As for efficiency, high efficiency is achieved when V_{ref} is set to 370 V in a region where the output electric current I_{O} is low and when V_{ref} is set to 400 V in a region where the output electric current I_{O} is high. Therefore, according to the PFC circuit 12 of FIG. 5, an output voltage V_{FCf} of the PFC circuit 12 is changed as described above in accordance with the output electric current I_{O} in order to achieve high efficiency.

Meanwhile, the response speed is low in the case of 370 V, and the response speed in the case of 400 V is higher than that in the case of 370 V. When the response is slow, a fluctuation of the output voltage V_{FCf} of the PFC circuit 12 becomes large upon occurrence of a rapid load fluctuation in the PFC circuit 12.

As in the case of FIG. 3, a case is considered below where the output electric current I_{O} rapidly fluctuates alternately between 0% and 50%. As a band of the fluctuation of the output electric current I_{O} is larger, a fluctuation of the output voltage V_{FCf} of the PFC circuit 12 is larger. Since a voltage switching point is less than 60% as long as the output electric current I_{O} fluctuates alternately between 0% and 50%, the output voltage V_{FCf} of the PFC circuit 12 is 370 V.

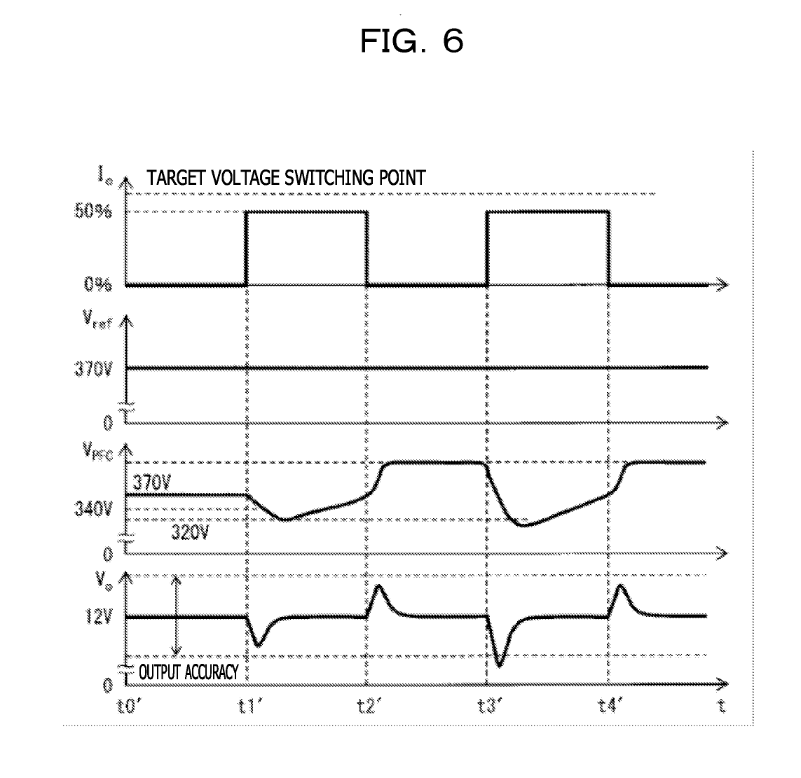

FIG. 6 is a timing diagram illustrating operation of the PFC circuit 12 of FIG. 5. In FIG. 6, a period t0′ to t1′ is similar to the period t0 to t1 of FIG. 3. During a period t1′ to t2′, V_{PFC} decreases. Since the target voltage is set to 370 V, the response speed is lower than that in the case of the target voltage 400 V of FIG. 3, and the amount of decrease in the voltage is larger than that in the case of FIG. 3. After the voltage decreases, the voltage follows the original voltage 370 V. During a period t2′ to t3′, V_{PFC} increases and reaches an overvoltage detection point. During a period t3′ to t4′, V_{PFC} decreases, feedback is saturated, and recovery from the overvoltage point is also slow because of the response speed in the case of V_{ref}=370 V (lower response speed than that in the case of V_{ref}=400 V). Accordingly, the amount of decrease in the voltage is larger than that during the t1′ to t2′.

When the output voltage V_{PFC} of the PFC circuit 12 fluctuates, an output voltage V_{O} of the DC/DC converting circuit 13 that is located in a stage following the PFC circuit 12 also fluctuates. Furthermore, in a case where the amount of fluctuation of the output voltage V_{PFC} of the PFC circuit 12 is large, the amount of fluctuation of the output voltage V_{O} of the DC/DC converting circuit 13 also becomes large. In general, output voltage accuracy (stability) is one element of the specification of an AC/DC converter. In order to satisfy this element of the specification concerning the output voltage accuracy, it is important to reduce a fluctuation of an output voltage even when a rapid electric current fluctuation occurs.

Furthermore, there has been a proposal of an AC/DC converter that uses another control method of changing an output voltage of a PFC circuit.

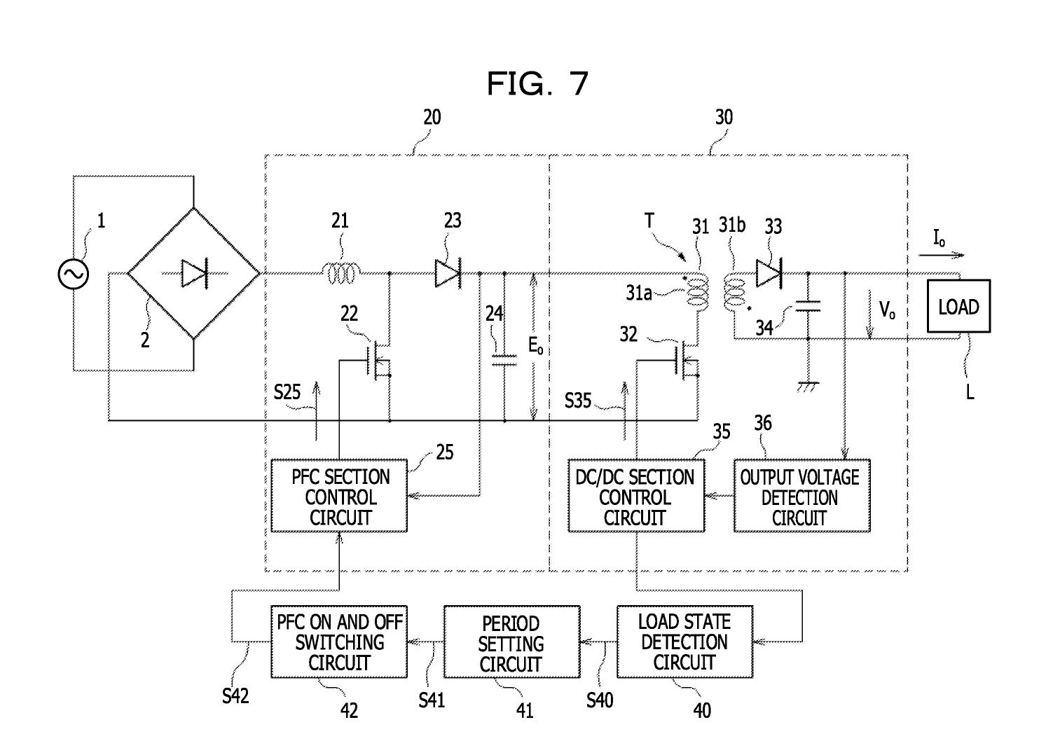

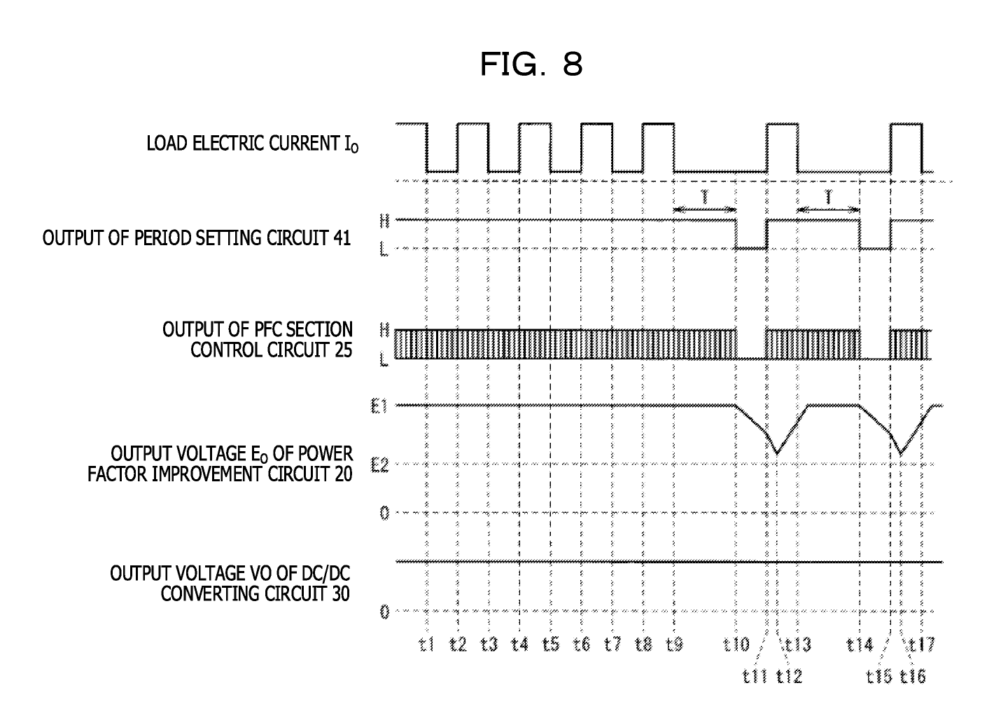

FIG. 7 is a circuit diagram of an AC/DC converter that uses another control method of changing an output voltage of a PFC circuit. FIG. 8 is a timing diagram illustrating operation of the AC/DC converter of FIG. 7.

Also in the AC/DC converter of FIG. 7, in order to achieve high efficiency of the circuit, an output voltage of the PFC circuit is controlled so that the output voltage is high in a region where an output electric current I_{O} is high and so that the output voltage is low in a region where the output electric current I_{O} is low. In the circuit of FIG. 7, a load state detection circuit 40 detects, based on data from a DC/DC section control circuit 35, whether a load state is light, in other words, an output electric current is low or the load state is heavy, in other words, the output electric current is high, instead of detecting the output electric current. A period setting circuit 41 outputs information on the load state detected by the load state detection circuit 40.

In this case, the period setting circuit 41 sets a period in accordance with a direction of a change of the load state. A PFC on and off switching circuit 42 controls, in accordance with the information on the load state transmitted via the period setting circuit 41, whether to turn on or off a PFC section control circuit 25. The PFC section control circuit 25 has an identical function to the voltage command generating circuit 50 of FIG. 2. In the AC/DC converter of FIG. 7, the PFC section control circuit 25 is turned on when the load state is heavy (when the output electric current is high), whereas the PFC section control circuit 25 is turned off when the load state is light (when the output electric current is low).

In this way, in the AC/DC converter of FIG. 7, high efficiency is achieved by controlling the output voltage of the PFC circuit through on and off control of the PFC section control circuit 25. Furthermore, when the load is lightened, the period setting circuit 41 transmits, to the PFC on and off switching circuit 42, information on the lightened load state at a delayed timing. Since a PFC circuit 20 is not turned off as soon as the load is lightened, but is turned off at a delayed timing, the output of the PFC circuit becomes stable even in a case where the load state fluctuates in a short time.

As described above, an output voltage of a PFC circuit is increased in order to increase the response speed. Meanwhile, an output voltage of the PFC circuit is lowered in a region where an electric current is low in order to increase efficiency. According to the AC/DC converter of FIG. 7, in a case where the output electric current becomes low, the PFC circuit 20 is stopped, that is, the output voltage of the PFC circuit 20 is lowered. This lowers the response speed. Accordingly, when an electric current fluctuation occurs in this case, the voltage fluctuation undesirably becomes large.

Furthermore, according to the AC/DC converter of FIG. 7, the PFC circuit 20 is turned off when the output electric current is low, and the PFC circuit 20 is turned on when the output electric current becomes large again. However, it takes a certain time to activate the PFC circuit 20. Since the PFC circuit 20 is under no control for the certain time, the response speed becomes low, and the voltage fluctuation undesirably becomes large when an electric current fluctuation occurs.

In the embodiments described below, an AC/DC converter that solves the above problems is disclosed. This AC/DC converter is an efficient AC/DC converter that outputs a stable voltage even at the occurrence of a fluctuation of a load (output electric current).

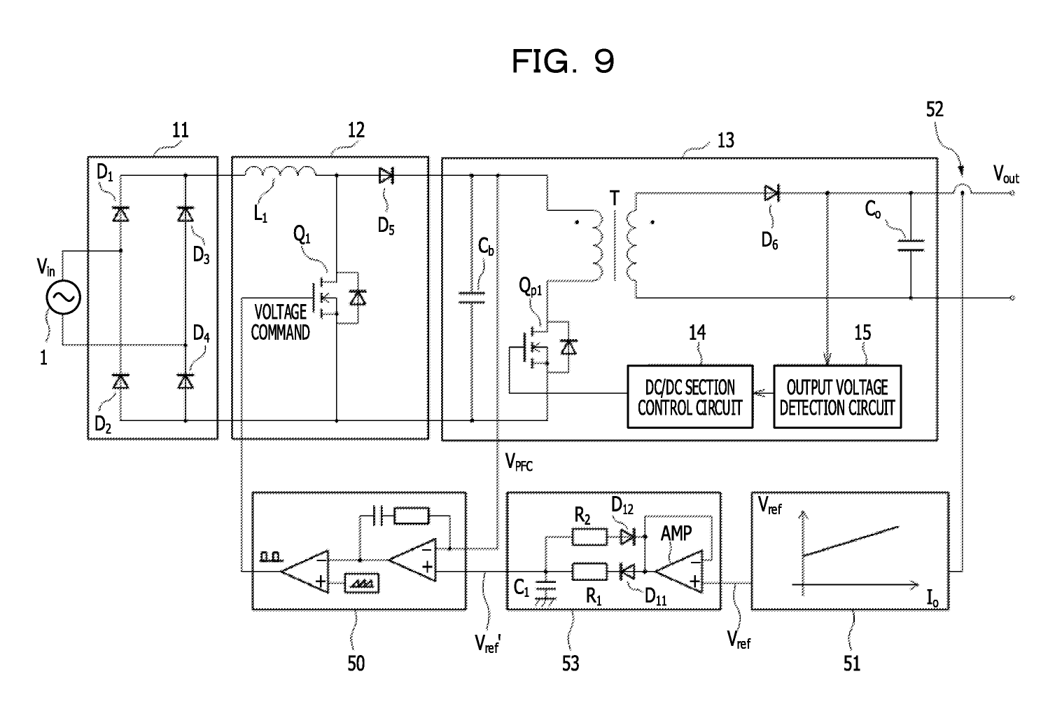

FIG. 9 is a circuit diagram of an AC/DC converter according to the first embodiment. The AC/DC converter according to the first embodiment includes a rectifier circuit 11, a PFC circuit 12, a DC/DC converting circuit 13, a voltage command generating circuit 50, a target voltage command generating circuit 51, an output electric current detection circuit 52, and a target voltage converting circuit 53. In other words, the AC/DC converter according to the first embodiment is different from the AC/DC converter of FIG. 5 in that the target voltage converting circuit 53 is provided. The AC/DC converter according to the first embodiment is identical to the AC/DC converter of FIG. 5 except for this point.

In the AC/DC converter according to the first embodiment, the output electric current detection circuit 52 detects an output electric current I_{O} of the DC/DC converting circuit 13, and the target voltage command generating circuit 51 outputs a target voltage V_{ref} of the PFC circuit 12 according to the output electric current I_{O} thus detected, as in the circuit of FIG. 5. The target voltage V_{ref} is generated so that the target voltage V_{ref} has a small value when the output electric current I_{O} is low and so that the target voltage V_{ref} has a large value when the output electric current I_{O} is high. The target voltage V_{ref} may change in proportion to the output electric current I_{O} or may change in stages. In the first embodiment, a low target voltage V_{ref} 370 V is outputted in a region where the output electric current I_{O} is low, and a high target voltage V_{ref} 400 V is outputted in a region where the output electric current I_{O} is high. Note that the target voltage V_{ref} outputted from the target voltage generating circuit 51 is used for computation, and is not necessarily this voltage value but may be a corresponding voltage, for example, a 1/50 scale voltage.

The target voltage converting circuit 53 converts the target voltage V_{ref} outputted from the target voltage generating circuit 51 into a converted target voltage V_{ref}′. As in FIGS. 2 and 5, the voltage command generating circuit 50 compares the output voltage V_{PFC} of the PFC circuit 12 with the converted target voltage V_{ref}′, generates a voltage command according to a difference between the output voltage V_{PFC} of the PFC circuit 12 and the converted target voltage V_{ref}′, and then gives the voltage command to Q₁. In the PFC circuit 12, on and off of Q₁ is thus controlled so that the output voltage V_{PFC} becomes the converted target voltage V_{ref}′.

As illustrated in FIG. 9, the target voltage converting circuit 53 includes an amplifier AMP, two diodes D₁₁ and D₁₂, two resistors R₁ and R₂, and a capacitor C₁. An inverting input and an output of the amplifier AMP are connected to each other, and the target voltage V_{ref} is inputted to a non-inverting input of the amplifier AMP. One terminal of the capacitor C₁ is connected to the output of the amplifier AMP via the diode D₁₁ and the resistor R₁ that are serially connected to each other and via the diode D₁₂ and the resistor R₂ that are serially connected to each other while the other terminal of the capacitor C₁ is grounded. In other words, the row of the diode D₁₁ and the resistor R₁ and the row of the diode D₁₂ and the resistor R₂ are connected in parallel to each other. The diode D₁₁ is connected in a forward direction from the output of the amplifier AMP toward the one terminal of the capacitor C₁, and the diode D₁₂ is connected in a reverse direction from the one terminal of the capacitor C₁ toward the output of the amplifier AMP. The resistance of the resistor R₂ is sufficiently larger than (for example, several tens of times larger than) the resistance of the resistor R₁. The converted target voltage V_{ref}′ is outputted from the one terminal of the capacitor C₁.

When the target voltage V_{ref} is low (=370 V), the non-inverting input, the inverting input and the output of the amplifier AMP and the one terminal of the capacitor C₁ are at a low level. When the target voltage V_{ref} becomes high (=400 V) in this state, the non-inverting input of the amplifier AMP becomes high. In response to this, an electric current flows from the amplifier AMP to the capacitor C₁ via the diode D₁₁ and the resistor R₁ that are serially connected to each other. This charges the capacitor C₁ and causes the inverting input and the output of the amplifier AMP and the one terminal of the capacitor C₁ to be high (=400 V). Since the resistance of the resistor R₁ is small, the electric potential of the one terminal of the capacitor C₁ rapidly increases in a short time.

Meanwhile, when the target voltage V_{ref} is high (=400 V), the non-inverting input, the inverting input and the output of the amplifier AMP and the one terminal of the capacitor C₁ are at a high level. When the target voltage V_{ref} becomes low (=370 V) in this state, the non-inverting input of the amplifier AMP becomes low. In response to this, an electric current flows from the capacitor C₁ to the amplifier AMP via the diode D₁₂ and the resistor R₂ that are serially connected to each other. This discharges the capacitor C₁ and causes the inverting input and the output of the amplifier AMP and the one terminal of the capacitor C₁ to be low (=370 V). Since the resistance of the resistor R₂ is large, the electric potential of the one terminal of the capacitor C₂ gradually decreases over a long time.

As described above, the target voltage converting circuit 53 rapidly increases the converted target voltage V_{ref}′ when the target voltage V_{ref} outputted from the target voltage generating circuit 51 becomes high, whereas the target voltage converting circuit 53 gradually decreases the converted target voltage V_{ref}′ when the target voltage V_{ref} becomes low. In this example, the capacitor C₁ functions as a capacitive element that holds the last converted target voltage, and the amplifier AMP whose inverting input and output are connected to each other functions as a charging and discharging circuit that charges or discharges the capacitor C₁ in accordance with a difference between the target voltage and the voltage held by the capacitor C₁. The diode D₁₁ and the resistor R₁ that are serially connected to each other function as a charging pathway connected between the capacitive element and the charging and discharging circuit, and the diode D₁₂ and the resistor R₂ that are serially connected to each other function as a discharging pathway connected between the capacitive element and the charging and discharging circuit.

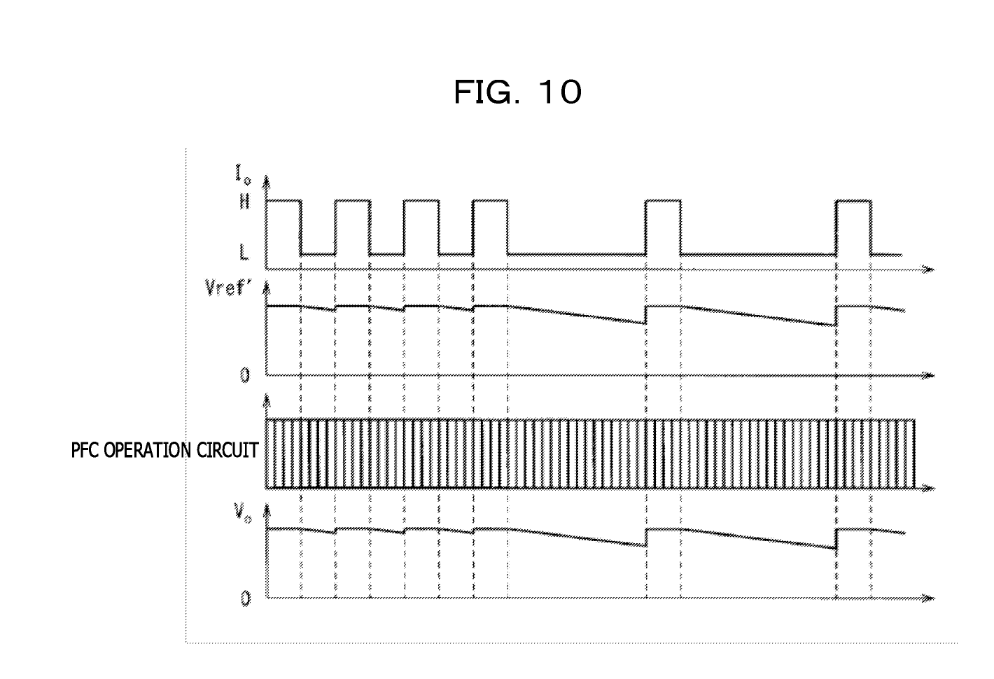

FIG. 10 is a timing diagram illustrating operation of the target voltage converting circuit 53 of the AC/DC converter according to the first embodiment.

In a case where the output electric current I_{O} changes as indicated by the electric current waveform in the topmost row of FIG. 10, the target voltage V_{ref} is set to a high voltage (H: High level) in an electric current region where the output electric current I_{O} is high (the vertical axis is H: High). Meanwhile, the target voltage V_{ref} is set to a low voltage (L: Low level) in an electric current region where the output electric current I_{O} is low (the vertical axis is L: Low). When the target voltage V_{ref} shifts from L to H, the target voltage converting circuit 53 converts the target voltage V_{ref} into the converted target voltage V_{ref}′ so that the target voltage V_{ref} instantly changes from L to H, whereas when the target voltage V_{ref} shifts from H to L, the target voltage converting circuit 53 converts the target voltage V_{ref} into the converted target voltage V_{ref}′ so that the target voltage V_{ref} gradually changes from H to L. The converted target voltage V_{ref}′ is indicated by the second row from the top in FIG. 10.

Therefore, when the target voltage V_{ref} shifts from L to H, this shift is instantly reflected in generation of a voltage command in the voltage command generating circuit 50, and the duty of the voltage command increases. Meanwhile, when the target voltage V_{ref} shifts from H to L, this shift is gradually reflected in generation of a voltage command in the voltage command generating circuit 50, and the duty of the voltage command decreases. Even in this case, the PFC circuit 12 continues to operate and be controlled, as indicated by the third row from the top in FIG. 10. In a case where the duty of the voltage command becomes zero, the PFC circuit 12 substantially ceases to operate, but operation of the voltage command generating circuit 50 is not stopped. In this way, the output voltage V_{O} of the PFC circuit 12 is controlled so as to follow the converted target voltage V_{ref}′ as indicated by the bottommost row in FIG. 10.

In the first embodiment, since the PFC circuit is not stopped even when the output electric current becomes low, it is possible to continue a controllable state. Furthermore, since the target voltage V_{ref} is gradually decreased in a case where the output electric current decreases, response of the PFC circuit is also delayed. Accordingly, even in a case where the output electric current shifts from H to L and the target voltage instantly shifts from L to H, the output voltage of the PFC circuit does not decrease yet, and therefore the response speed remains high. Consequently, a voltage fluctuation becomes small.

Meanwhile, in a case where the output electric current shifts from L to H and the target voltage shifts from H to L, this change is instantly reflected in a voltage command, and the output voltage of the PFC circuit instantly increases, and therefore the response speed instantly becomes high. Consequently, a voltage fluctuation is small.

In the AC/DC converter circuit illustrated in FIG. 7, when a low output electric current is detected, an output voltage is decreased after a certain time. Meanwhile, in the first embodiment, the output voltage is gradually decreased. Therefore, efficiency during this certain time becomes higher. Furthermore, an AC/DC converter used in a server apparatus is generally used in a high electric current region. Therefore, the method of basically keeping a high voltage that achieves high efficiency and gradually decreasing the voltage upon entry into a low electric current region is more advantageous in terms of efficiency than the method of instantly decreasing an output voltage of a PFC circuit.

As has been described above, in the AC/DC converter according to the first embodiment, the PFC circuit is not stopped even in a case where the output electric current decreases. This makes it possible to continue controlling a voltage.

Furthermore, when a decrease of the output electric current is detected, the output voltage of the PFC circuit is decreased although the decrease of the output voltage is gradual. This achieves higher efficiency during a period of time in which the output voltage of the PFC circuit is decreased.

Furthermore, in a case where the output electric current decreases, the output voltage of the PFC circuit is gradually decreased. Therefore, even in a case where an electric current fluctuation occurs over a short cycle as illustrated in FIG. 10, a voltage fluctuation is small because of a high response speed.

In the AC/DC converter according to the first embodiment, each of the voltage command generating circuit 50, the target voltage command generating circuit 51, and the target voltage converting circuit 53 is realized by an analog circuit, but all of or part of these circuits may be realized by a digital processing circuit. In an AC/DC converter according to the second embodiment described below, a target voltage command generating circuit 51 and a target voltage converting circuit 53 are realized by an analog circuit.

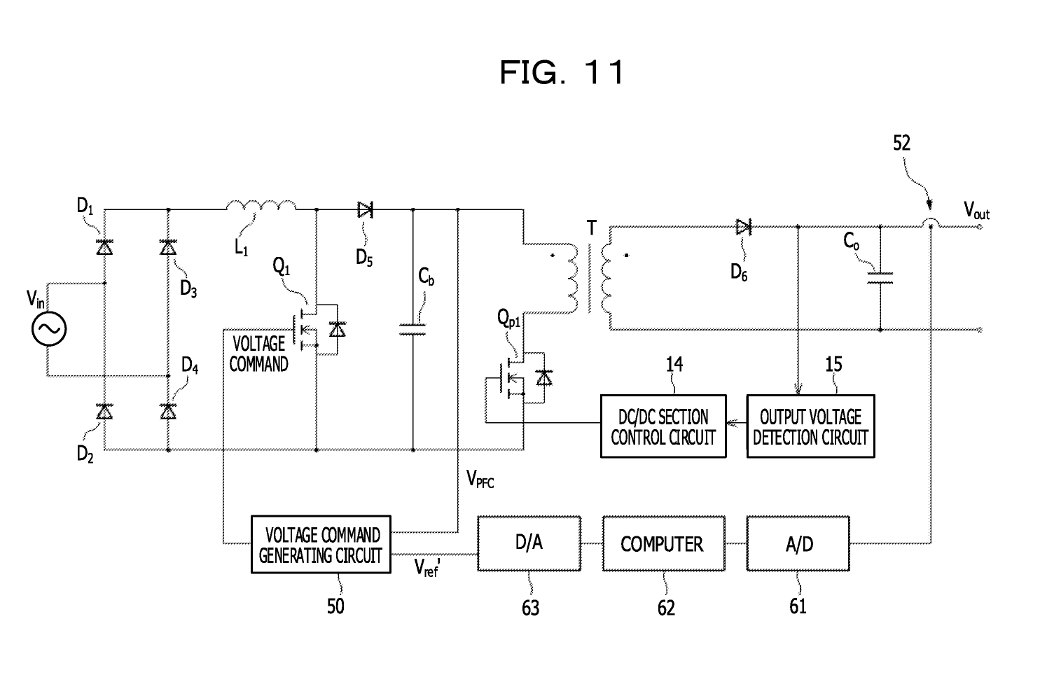

FIG. 11 is a diagram illustrating a circuit configuration of the AC/DC converter according to the second embodiment. The AC/DC converter according to the second embodiment is different from the AC/DC converter according to the first embodiment in that an A/D converter 61, a computer 62, and a D/A converter 63 are provided instead of the target voltage command generating circuit 51 and the target voltage converting circuit 53 and that functions of these circuits are achieved by digital processing.

The A/D converter 61 converts an output electric current I_{O} detected by an output electric current detection circuit 52 into a digital signal. The computer 62 is, for example, realized by a microcomputer and performs, based on data of the output electric current I_{O} outputted by the A/D converter 61, digital processing corresponding to the analog processing of the target voltage command generating circuit 51 and the target voltage converting circuit 53 in the first embodiment. That is, a target voltage V_{ref} is calculated from the data of the output electric current I_{O}, and a converted target voltage V_{ref}′ is generated in accordance with a direction of a change of the output electric current I_{O}. The D/A converter 63 converts the converted target voltage V_{ref}′ into an analog signal, and outputs the analog signal to the voltage command generating circuit 50. Further explanation is omitted since it is easy for a person skilled in the art to perform digital processing instead of the analog processing described in the first embodiment. The second embodiment produces similar effects to those of the first embodiment.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An AC/DC converter comprising:
a rectifier circuit that rectifies an alternating current input;
a PFC circuit that has an inductance element, a switching element, and a diode and steps up and outputs an output of the rectifier circuit in accordance with a target voltage by controlling on and off of the switching element;
a DC/DC converting circuit that converts an output of the PFC circuit into a direct current voltage power source of a predetermined voltage value;
a target voltage command generating circuit that designates the target voltage so that the target voltage is low in a region where an output electric current of the DC/DC converting circuit is low and so that the target voltage is high in a region where the output electric current of the DC/DC converting circuit is high;
a target voltage converting circuit that generates a converted target voltage by converting the target voltage designated by the target voltage command generating circuit so that the target voltage is changed in a first period when the output electric current of the DC/DC converting circuit is shifted from low to high and so that the target voltage is changed in a second period longer than the first period when the output electric current of the DC/DC converting circuit is shifted from high to low; and
a voltage command generating circuit that generates an on and off control signal for controlling on and off of the switching element of the PFC circuit in accordance with the converted target voltage.

2. The AC/DC converter according to claim 1, wherein:
the target voltage converting circuit includes:
a capacitive element that holds the last converted target voltage;
a charging and discharging circuit that charges or discharges the capacitive element in accordance with a difference between the target voltage designated by the target voltage command generating circuit and the voltage held by the capacitive element;
a charging pathway coupled between the capacitive element and the charging and discharging circuit; and
a discharging pathway coupled between the capacitive element and the charging and discharging circuit;
wherein resistance of the charging pathway is smaller than resistance of the discharging pathway.

3. The AC/DC converter according to claim 2, wherein:
the charging pathway has a first diode and a first resistor that are serially coupled to each other;
the first diode is coupled in a forward direction from the charging and discharging circuit toward the capacitive element;
the discharging pathway has a second diode and a second resistor that are serially coupled to each other;
the second diode is coupled in a reverse direction from the capacitive element toward the charging and discharging circuit; and
resistance of the second resistor is larger than resistance of the first resistor.

4. An AC/DC converting method for rectifying an alternating current input, stepping up a rectified voltage in accordance with a target voltage, performing DC/DC conversion of the rectified voltage thus stepped up into a direct current voltage of a predetermined voltage value, and then outputting the direct current voltage, comprising:
detecting a DC/DC converted output electric current;
designating the target voltage so that the target voltage is low in a region where the output electric current thus detected is low and so that the target voltage is high in a region where the output electric current thus detected is high;
generating a converted target voltage by converting the target voltage so that the target voltage is changed in a first period when the output electric current is shifted from low to high and so that the target voltage is changed in a second period longer than the first period when the output electric current is shifted from high to low; and
controlling stepping-up of the rectified voltage in accordance with the converted target voltage.
